(19) United States
(12) Patent Application Publication
(10) Pub. No.: US 2021/0127147 A1
(43) Pub. Date: Apr. 29, 2021

(54) METHOD AND APPARATUS FOR PROVIDING CONTENT USING EDGE COMPUTING SERVICE

(71) Applicant: SAMSUNG ELECTRONICS CO., LTD., Suwon-si (KR)

(72) Inventor: Seungyoung SHIN, Suwon-si, Gyeonggi-do (KR)

(21) Appl. No.: 17/072,751

(22) Filed: Oct. 16, 2020

(30) Foreign Application Priority Data
Oct. 25, 2019 (KR) 10-2019-0134098

(51) Int. Cl. H04N 21/239; H04N 21/2343; H04N 21/431; H04N 21/262; H04N 21/231; H04N 21/258

(52) U.S. Cl. CPC H04N 21/2393; H04N 21/234309; H04N 21/25841; H04N 21/26258; H04N 21/23106; H04N 21/4312

(57) ABSTRACT

Provided are a method and apparatus for providing content using an edge computing service. A method, performed by an edge data network, of providing a streaming service to a terminal includes caching a plurality of content related to the streaming service; receiving, from the terminal, a message for requesting content list information corresponding to the terminal; determining the content list information corresponding to the terminal from the cached plurality of content, based on the message for requesting the content list information; transmitting the determined content list information to the terminal; receiving, from the terminal, a playback request message for at least one content selected based on the content list information; and providing, to the terminal, data about the at least one content, based on the playback request message.

### CROSS-REFERENCE TO RELATED APPLICATION

This application is based on and claims priority under 35 U.S.C. § 119 to Korean Patent Application No. 10-2019-0134098, filed on Oct. 25, 2019, in the Korean Intellectual Property Office, the disclosure of which is incorporated by reference herein in its entirety.

### BACKGROUND

### 1. Field

The disclosure relates to an edge computing service (e.g., a multi-access edge computing (MEC) service), and for example, to a method and apparatus for providing content using an edge computing service.

### 2. Description of Related Art

Recently, edge computing technology for transmitting data using an edge server has been discussed. Edge computing technology may include, for example, multi-access edge computing (MEC) or fog computing (FOC). Edge computing technology may refer to technology of providing data to an electronic device through a separate server (hereinafter, an ‘edge data network’ or a ‘MEC server’) provided at a location geographically close to the electronic device, for example, inside or near a base station. For example, an application requiring a low latency from among at least one application installed in the electronic device may transmit or receive data through an edge server provided at a geographically close location instead of a server located in an external data network (DN) (e.g., the Internet).

Recently, a service using edge computing technology (hereinafter, referred to as a ‘MEC-based service’ or a ‘MEC service’) has been discussed and research on and development of an electronic device are being conducted to support the MEC-based service. For example, an application of the electronic device may transmit or receive edge computing-based data on an application layer to or from an edge server (or an application of the edge server).

As research and development for supporting a MEC-based service are being conducted, methods for efficiently providing a MEC-based streaming service are being discussed.

### SUMMARY

Embodiments of the disclosure provide a method and apparatus for providing content using an edge computing service, based on the aforementioned discussion.

Embodiments of the disclosure provide a method and apparatus for providing a multi-access edge computing (MEC)-based streaming service.

Embodiments of the disclosure provide a method and apparatus for providing a real time streaming service to a terminal connected to an edge data network.

Embodiments of the disclosure provide a method and apparatus for providing an effective real time broadcast channel search service.

Embodiments of the disclosure provide a method and apparatus for providing content related to a streaming service, using augmented reality (AR).

Additional aspects will be set forth in part in the description which follows and, in part, will be apparent from the description.

According to an example embodiment of the disclosure, a method, performed by an edge data network, of providing a streaming service to a terminal includes: caching a plurality of content related to the streaming service; receiving, from the terminal, a message for requesting content list information corresponding to the terminal; determining the content list information corresponding to the terminal from the cached plurality of content, based on the message for requesting the content list information; transmitting the determined content list information to the terminal; receiving, from the terminal, a playback request message for at least one content selected based on the content list information; and providing, to the terminal, data about the at least one content, based on the playback request message.

According to an example embodiment of the disclosure, an operating method of a terminal for receiving a streaming service from an edge data network includes: transmitting, to the edge data network, a message for requesting content list information corresponding to the terminal; receiving, from the edge data network, the content list information corresponding to the terminal determined from a plurality of cached content related to the streaming service; transmitting, to the edge data network, a playback request message for at least one content selected based on the content list information; and receiving data about the at least one content, from the edge data network.

According to an example embodiment of the disclosure, an edge data network for providing a streaming service to a terminal includes: a communicator; a memory configured to store a plurality of instructions; and a processor configured to execute the plurality of instructions to cache a plurality of content related to the streaming service, receive, from the terminal, a message for requesting content list information corresponding to the terminal, determine the content list information corresponding to the terminal, from the cached plurality of content, based on the message for requesting the content list information, transmit the determined content list information to the terminal, receive, from the terminal, a playback request message for at least one content selected based on the content list information, and provide, to the terminal, data about the at least one content, based on the playback request message.

According to an example embodiment of the disclosure, a terminal for receiving a streaming service from an edge data network includes: a communicator; a memory configured to store a plurality of instructions; and a processor configured to execute the plurality of instructions to transmit, to the edge data network, a message for requesting content list information corresponding to the terminal, receive, from the edge data network, the content list information corresponding to the terminal determined from a plurality of cached content related to the streaming service, transmit, to the edge data network, a playback request message for at least one content selected based on the content list information, and receive data about the at least one content, from the edge data network.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an example multi-access edge computing (MEC) technology in a network environment, according to various embodiments;

FIG. 2 is a signal flow diagram illustrating an example operating procedure of a plurality of apparatuses for providing a MEC-based streaming service, according to various embodiments;

FIG. 3 is a signal flow diagram illustrating an example operating procedure between an edge data network and a terminal for providing a MEC-based streaming service, according to various embodiments;

FIG. 4 is a flowchart illustrating an example operating method of an edge data network, according to various embodiments;

FIG. 5 is a flowchart illustrating an example operating method of an edge data network for determining content list information according to various embodiments;

FIG. 6 is a flowchart illustrating an example operating method of an edge data network for performing transcoding on content, according to various embodiments;

FIG. 7 is a flowchart illustrating an example operating method of a terminal, according to various embodiments;

FIG. 8 is a diagram illustrating example scenarios of providing a streaming service according to various embodiments;

FIG. 9 is a diagram illustrating an example of providing a streaming service according to various embodiments;

FIG. 10 is a diagram illustrating an example method used to generate content list information, according to various embodiments;

FIG. 11 is a diagram illustrating an example method of generating content list information using augmented reality (AR), according to various embodiments;

FIG. 12 is a signal flow diagram illustrating an example procedure of providing content related to a streaming service, according to various embodiments;

FIG. 13 is a signal flow diagram illustrating an example procedure of providing content related to a streaming service, according to various embodiments;

FIG. 14 is a block diagram illustrating an example configuration of an edge data network according to various embodiments; and

FIG. 15 is a block diagram illustrating an example configuration of a terminal according to various embodiments.

### DETAILED DESCRIPTION

Hereinafter, various example embodiments of the disclosure will be described in greater detail with reference to the accompanying drawings.

While describing embodiments of the disclosure, descriptions of techniques that are well known in the art and not directly related to the disclosure may be omitted for clarity.

Some elements in the attached drawings may be exaggerated, omitted, or schematically illustrated. Also, the size of each component does not completely reflect the actual size of the element. In the drawings, the same or corresponding elements are denoted by the same reference numerals.

The advantages and features of the disclosure and methods of achieving them will become apparent with reference to example embodiments of the disclosure described in detail below along with the attached drawings. The disclosure may, however, be embodied in many different forms and should not be construed as limited to embodiments of the disclosure set forth herein; rather these embodiments of the disclosure are illustrative, not limiting, and will convey the scope of the disclosure to one of ordinary skill in the art. In the disclosure, the same reference numerals denote the same elements.

Throughout the disclosure, the expression “at least one of a, b or c” indicates only a, only b, only c, both a and b, both a and c, both b and c, all of a, b, and c, or variations thereof.

A terminal may include a user equipment (UE), a mobile station (MS), a cellular phone, a smartphone, a computer, or a multimedia system capable of performing a communication function.

In the disclosure, a controller may also be referred to as a processor.

In the disclosure, a layer (or a layer apparatus) may also be referred to as an entity.

It will be understood that each block of flowchart illustrations and combinations of blocks in the flowchart illustrations may be implemented by computer program instructions. Because these computer program instructions may be loaded into a processor of a general-purpose computer, special purpose computer, or other programmable data processing apparatus, the instructions, which are executed via the processor of the computer or other programmable data processing apparatus, generate means for implementing the functions specified in the flowchart block(s). Because these computer program instructions may also be stored in a computer usable or computer-readable memory that may direct a computer or other programmable data processing apparatus to function in a particular manner, the instructions stored in the computer usable or computer-readable memory may produce an article of manufacture including instruction means that implement the functions specified in the flowchart block(s). Because the computer program instructions may also be loaded onto a computer or other programmable data processing apparatus, a series of operational steps may be performed on the computer or other programmable apparatus to produce a computer implemented process, and thus the instructions executed on the computer or other programmable apparatus may provide steps for implementing the functions specified in the flowchart block(s).

In addition, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The term “˜ unit” used in the present embodiment of the disclosure may refer, for example, to a software or hardware component, such as a field-programmable gate array (FPGA) or an application-specific integrated circuit (ASIC), which performs certain tasks. However, “˜ unit” is not limited to software or hardware. The “˜ unit” may be configured to be in an addressable storage medium or configured to operate one or more processors. Thus, “˜ unit” may include, by way of example, components, such as software components, object-oriented software components, class components, and task components, processes, functions, attributes, procedures, subroutines, segments of program code, drivers, firmware, microcode, circuitry, data, databases, data structures, tables, arrays, and variables. The functionality provided in components and “˜ units” may be combined into fewer components and “˜ units” or further separated into additional components and “˜ units”. Further, components and “˜ units” may be implemented to operate one or more central processing units (CPUs) in a device or a secure multimedia card. Also, a unit may include one or more processors in an embodiment.

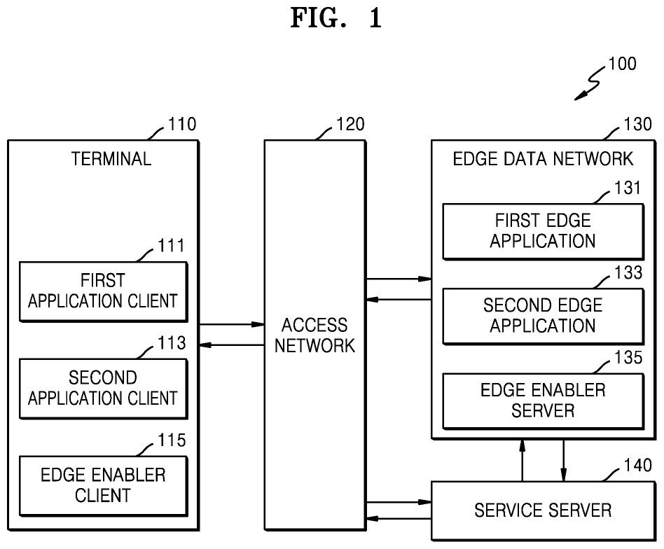

FIG. 1 is a block diagram illustrating an example multi-access edge computing (MEC) technology in a network environment 100 according to various embodiments.

Referring to FIG. 1, the network environment 100 of the disclosure may include a terminal 110, an access network (AN) 120, an edge data network 130, and a service server 140. Also, although not shown in FIG. 1, the network environment 100 of the disclosure may include an edge data network configuration server.

That is, the network environment 100 of the disclosure may include a plurality of elements for supporting a MEC-based service. However, components included in the network environment 100 are not limited to the components illustrated in FIG. 1.

According to various embodiments, each of the components included in the network environment 100 may refer to a physical entity unit or may refer to a software or module unit capable of performing an individual function.

According to various embodiments, the terminal 110 may refer to an apparatus used by a user. For example, the terminal 110 may be a terminal, a user equipment (UE), a mobile station, a subscriber station, a remote terminal, a wireless terminal, or a user device. Referring to FIG. 1, the terminal 110 may include a first application client (or an application client) 111, a second application client 113, and an edge enabler client (or a MEC enabling layer (MEL)) 115. The terminal 110 may perform a necessary task using the edge enabler client 115 so as to use a MEC service.

Although not shown in FIG. 1, according to various embodiments, the terminal 110 may include a multi-access service agent (MSA) and a multi-access service enabler (MSE). According to various embodiments, the MSA may receive information related to authentication of the terminal 110, authorization and policy (e.g., an app routing policy, a discovery policy, or a monitoring policy). The MSE may set a route according to the policy and manage MEC-based data transmission. According to various embodiments, the edge enabler client 115 may refer to an element that performs a task required to use a MEC service among services of the MSE.

According to various embodiments of the disclosure, the terminal 110 may execute a plurality of applications. For example, the terminal 110 may execute the first application client 111 and the second application client 113. The plurality of applications may require different network services based on at least one of a required data transmission speed, a latency (or a speed), reliability, the number of electronic devices accessing a network, a network accessing cycle of the terminal 110, or average data usage. The different network services may include, for example, enhanced mobile broadband (eMBB), ultra-reliable and low latency communication (URLLC), or massive machine type communication (mMTC).

An application client of the terminal 110 may refer, for example, to a basic application pre-installed in the terminal 110 or an application provided by a third party. In other words, the application client may refer to a client application program driven in the terminal 110 for a particular application service. Several application clients may be driven in the terminal 110. At least one of the application clients may use a service provided from the edge data network 130. For example, the application client may be an application installed in and executed by the terminal 110, and may provide a function of transmitting or receiving data through the edge data network 130. The application client of the terminal 110 may refer to application software executed on the terminal 110 to use a function provided by at least one particular edge application.

According to various embodiments, a plurality of application clients (e.g., the first application client 111 and the second application client 113) of the terminal 110 may perform data transmission with the service server 140 based on a required network service type, or may perform data transmission based on edge computing with the edge data network 130. For example, when the first application client 111 does not require a low latency, the first application client 111 may perform data transmission with the service server 140. As another example, when the second application client 113 requires a low latency, the second application client 113 may perform MEC-based data transmission with the edge data network 130.

According to various embodiments, an application of the terminal 110 may be referred to as an application client, a client application (client app), or a UE application (UE app). For convenience of description, hereinafter, an application of the terminal 110 is referred to as an application client.

According to various embodiments, the AN 120 may provide a channel for wireless communication with the terminal 110. For example, the AN 120 may refer to a radio access network (RAN), a base station, an eNodeB (eNB), a 5th generation (5G) node, a transmission/reception point (TRP), or a 5th generation nodeB (5GNB).

According to various embodiments, the edge data network 130 may refer, for example, to a server accessed by the terminal 110 to use the MEC service. The edge data network 130 may be provided at a location geographically close to an electronic device, for example, inside a base station or near the base station. According to various embodiments, the edge data network 130 may transmit or receive data to or from the terminal 110 without passing through an external data network (DN) (e.g., the Internet). According to various embodiments, MEC may be referred to as multi-access edge computing or mobile-edge computing.

According to various embodiments, the edge data network 130 may be referred to as a MEC host, an edge computing server, a mobile edge host, an edge computing platform, or a MEC server. For convenience of description, hereinafter, the MEC server is referred to as the edge data network 130. Referring to FIG. 1, the edge data network 130 may include a first edge application 131, a second edge application 133, and an edge enabler server (or a MEC platform (MEP)) 135. The edge enabler server 135 may refer to a component for providing the MEC service or performing traffic control in the edge data network 130.

According to various embodiments, the edge data network 130 may execute a plurality of applications. For example, the edge data network 130 may execute the first edge application 131 and the second edge application 133. According to various embodiments, an edge application may refer to an application provided by a third party in an edge data network providing a MEC service and may be referred to as an edge application. The edge application may be used to form a data session with an application client to transmit or receive data related to the application client. In other words, the edge application may provide the data session with the application client. According to various embodiments, data session may refer to a communication path formed so that an application client of the terminal 110 and an edge application of the edge data network 130 can transmit or receive data.

According to various embodiments, an application of the edge data network 130 may be referred to as a MEC application (MEC app or ME app), an edge application server, or an edge application. For convenience, hereinafter, the application of the edge data network 130 is referred to as an edge application. Here, the edge application may refer to an application server present in an edge data network.

According to various embodiments, the service server 140 may provide content related to an application. For example, the service server 140 may be managed by a content provider. According to various embodiments of the disclosure, the service server 140 may transmit or receive data to or from the terminal 110 through an external DN (e.g., the Internet). For example, the service server 140 may refer to a server (e.g., a Youtube cloud server, an AfreecaTV server, or a Twitch server) that may provide data related to a streaming service.

Although not shown in FIG. 1, the network environment 100 may include an edge data network configuration server. In various embodiments, the edge data network configuration server may provide edge data configuration information to the edge enabler client 115 in the terminal 110. For example, the edge data network configuration server may provide configuration information for using the MEC service (e.g., information about an edge data network that provides a service to a certain area or information for identifying the edge data network) to the edge data network 130 or the terminal 110. In various embodiments, the edge data network configuration server may be referred to as an edge data network management server, an edge configuration server, or a configuration server, and may perform a function of a mobile edge platform manager (MEPM) or a multi-access edge orchestrator (MEO).

Although not shown in FIG. 1, a core network (CN) and a DN may be present between the AN 120 and the edge data network 130. According to various embodiments, the DN may provide a service (e.g., an Internet service or an IP multimedia subsystem (IMS) service) by transmitting or receiving data (or a data packet) to or from the terminal 110 through the CN and the AN 120. For example, the DN may be managed by a communication provider. According to various embodiments, the edge data network 130 may be connected to the AN 120 or the CN through the DN (e.g., a local DN).

With the development of information and communication technology (ICT) technology and the distribution of high-end smartphones, Internet-centered one-person media have rapidly increased. Accordingly, subscriptions of viewers to streaming services such as sports streaming and product launch streaming through one-person media have also increased. However, in the case of a live broadcast of a sports event such as sports streaming, because a streamer uploads a live video and a viewer downloads a video from a local stream platform server such as a content delivery network or content distribution network (CDN), latency may occur. Also, when the viewer searches for a desired live broadcast channel, a procedure of inputting information about the desired live broadcast channel to a terminal and searching for the desired live broadcast channel is required. In this case, due to the procedure, the viewer may experience inconvenience in searching and switching a broadcast channel. Also, a 5th generation (5G) communication system requires location information of a terminal using the 5G communication system within several meters (e.g., 2 meters). Accordingly, high accuracy of the location information of the terminal may be achieved.

In order to solve problems with existing streaming services, location information with high accuracy achieved in a 5G communication may be used. That is, the disclosure provides a method, performed by an edge data network, of obtaining location information of a streamer terminal and a packet transmitted to a platform related to a live broadcast, and providing a live broadcast service to a viewer connected to the edge data network. Also, the edge data network may obtain location information of the streamer terminal and a viewer terminal. The edge data network may provide a streaming service to the viewer terminal connected to the edge data network, based on the obtained location information.

The term “streaming” used herein may refer, for example, to technology in which data is transmitted through the Internet or by the edge data network 130 to the terminal 110 and is played in real time. A streaming service may refer, for example, to a service of playing various content in real time in a terminal using streaming technology. In an embodiment of the disclosure, streaming may include live streaming. Live streaming may refer, for example, to streaming in real time by transmitting a video obtained using a digital video (DV) camera or the like through a computer network, using streaming technology.

The term “streamer terminal” used herein may refer, for example, to a terminal that performs streaming. For example, a streamer terminal may refer, for example, to a terminal that creates streaming media such as live broadcast. That is, a streamer terminal may refer, for example, to a terminal that broadcasts an image captured by the streamer terminal, an image displayed on the streamer terminal, or an image stored in the streamer terminal through the edge data network 130 or the Internet so that other terminals view the image.

The term “content” used herein may refer, for example, to a voice or a video itself that may be streamed, or may refer to a channel through which a voice or a video is streamed.

The term “content list” used herein may refer, for example, to a set of content. Also, content list information may refer, for example, to information related to a content list. For example, content list information may include information about a plurality of content provided from a plurality of streamer terminals.

The term “caching” used herein may refer, for example, to technology of obtaining data in advance from a data-providing apparatus (e.g., a terminal or a server) and storing the data, before there is a request for the data. Due to caching, data may be provided with a low latency when there is a request for the data.

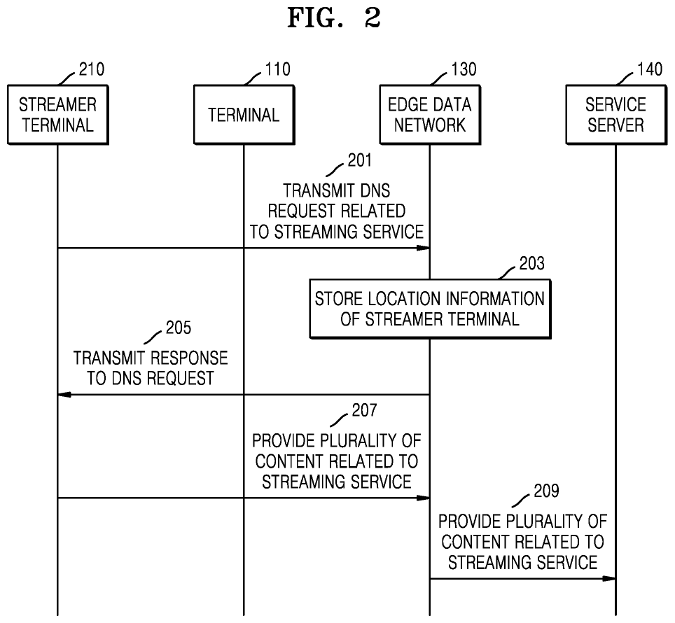

FIG. 2 is a signal flow diagram illustrating an example operating procedure of a plurality of apparatuses for providing a MEC-based streaming service according to various embodiments.

In FIG. 2, a network environment may include a streamer terminal 210, the terminal 110, the edge data network 130, and the service server 140. However, the disclosure is not limited thereto, and the network environment of FIG. 2 may further include additional elements. The terminal 110 used herein may refer to a viewer terminal that may view content provided by the streamer terminal 210. That is, when the streamer terminal 210 performs a live broadcast, the terminal 110 may play the live broadcast in the terminal 110.

Referring to FIG. 2, in operation 201, the streamer terminal 210 may transmit a domain name system (DNS) request related to a streaming service. For example, the streamer terminal 210 may execute an application for performing streaming. In this case, the application executed by the streamer terminal 210 may be an application through which the edge data network 130 may provide a service. The streamer terminal 210 may transmit the DNS request to the edge data network 130, in order to drive the application on the edge data network 130. In various embodiments, the DNS request may refer to a message transmitted by the streamer terminal 210, in order to obtain an Internet protocol (IP) address of the service server 140 that provides the streaming service.

Although not shown in FIG. 2, the edge data network 130 may transmit the DNS request received from the streamer terminal 210 to a DNS server (e.g., a local DNS server). When the DNS server receiving the DNS request knows the IP address of the service server 140, the DNS server may transmit the stored IP address of the service server 140 to the edge data network 130. Alternatively, when the DNS server receiving the DNS request does not know the IP address of the service server 140, the DNS server may ask another DNS server for the IP address and may receive information about the IP address from the other DNS server. The DNS server may transmit the IP address of the service server 140 to the edge data network 130.

In operation 203, the edge data network 130 may store location information of the streamer terminal 210. That is, the edge data network 130 may receive the DNS request related to the streaming service and may recognize the streaming service. The edge data network 130 may store the location information of the streamer terminal 210. For example, the edge data network 130 may receive the IP address of the service server 140 from the DNS server as described above in operation 201. The edge data network 130 may determine that the IP address of the service server 140 is the IP address of the service server 140 that provides the streaming service, based on the received IP address of the service server 140.

Accordingly, the edge data network 130 may recognize that the streamer terminal 210 requests the streaming service. The edge data network 130 recognizing that the streaming service is requested may store the location information of the streamer terminal 210. In this case, the location information of the streamer terminal 210 may be included in the DNS request transmitted from the streamer terminal 210 to the edge data network 130 in operation 201. Alternatively, the location information of the streamer terminal 210 may be transmitted from the streamer terminal 210 to the edge data network 130, separately from the DNS request. Alternatively, the edge data network 130 may obtain the location information of the streamer terminal 210 from a 3^{rd} generation partnership project (3GPP) network. In various embodiments, the 3GPP network (i.e., a wireless communication system following 3GPP standards) may provide a wireless communication service to the streamer terminal 210.

In various embodiments, the edge data network 130 may request the 3GPP network (or a network exposure function (NEF) of the 3GPP network) for the location information of the streamer terminal 210, and may obtain the location information of the streamer terminal 210 from the 3GPP network. For example, the edge data network 130 may request the NEF of the 3GPP network to subscribe to event reporting related to a location of the streamer terminal 210 provided by the NEF. The edge data network 130 may receive an event report including the location information of the streamer terminal 210 from the NEF.

According to various embodiments, regarding a service of subscribing to the event reporting related to the location of the streamer terminal 210, requested by the edge data network 130 to the NEF of the 3GPP network, a method of subscribing to the event reporting related to the location of the streamer terminal 210 may be set. For example, the number of event reports, a reporting period, whether to report periodically, and a reporting periodicity may be set. Accordingly, the edge data network 130 may obtain the location information of the streamer terminal 210, by setting the method of subscribing to the event reporting related to the location of the streamer terminal 210, from the 3GPP network (or the NEF of the 3GPP network).

In operation 205, the edge data network 130 may transmit a response to the DNS request. For example, the edge data network 130 may transmit the information about the IP address of the service server 140 received from the DNS server to the streamer terminal 210. Although operation 205 is performed after operation 203 in FIG. 2, the disclosure is not limited thereto. That is, operation 205 may be performed before or simultaneously with operation 203.

In operation 207, the streamer terminal 210 may provide a plurality of content related to the streaming service. For example, when the streamer terminal 210 performs streaming of a video, the streamer terminal 210 may transmit a data packet related to the video to the edge data network 130. Alternatively, when the streamer terminal 210 performs streaming of music, the streamer terminal 210 may transmit a data packet related to the music to the edge data network 130.

In operation 209, the edge data network 130 may provide the plurality of content related to the streaming service. The edge data network 130 receiving the plurality of content related to the streaming service from the streamer terminal 210 in operation 207 may transmit the received plurality of content to the service server 140. In various embodiments, the edge data network 130 may transmit information related to the received plurality of content (content-related information) to the service server 140. For example, the content-related information may include an icon related to the content and the location information of the streamer terminal 210 that transmits the content.

Although not shown in FIG. 2, the streamer terminal 210 may be a terminal connected by wire or wirelessly to the edge data network 130, or may be a terminal not connected by wire or wirelessly to the edge data network 130. In various embodiments, when the streamer terminal 210 is a terminal connected to the edge data network 130, as described in operation 209, the edge data network 130 may receive the plurality of content from the streamer terminal 210 and may transmit the received plurality of content to the service server 140.

Alternatively, when the streamer terminal 210 is a terminal not connected to the edge data network 130, the streamer terminal 210 may directly provide the plurality of content related to the streaming service to the service server 140. In this case, the service server 140 may transmit the received plurality of content to the edge data network 130. In contrast, the service server 140 may transmit the information related to the plurality of content (the content-related information) including the icon related to the received plurality of content and the location information of the streamer terminal 210 related to the received plurality of content to the edge data network 130.

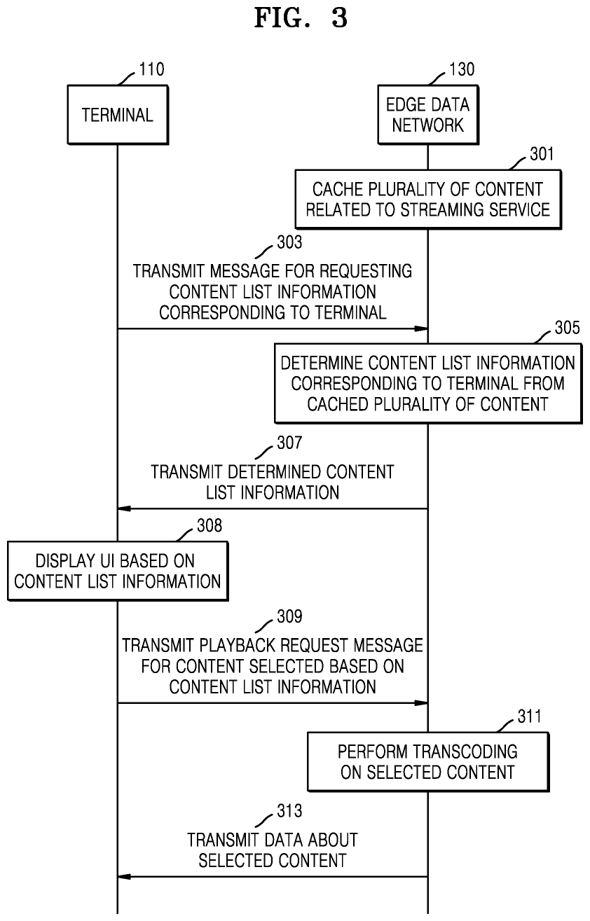

As described above with reference to FIG. 2, the edge data network 130 may store the location information of the streamer terminal 210 based on the DNS request from the streamer terminal 210, and the streamer terminal 210 may provide the plurality of content related to the streaming service to the edge data network 130. A method, performed by the edge data network 130, of providing a plurality of content related to a streaming service received from the streamer terminal 210 to the terminal 110 will be described in detail with reference to FIG. 3.

FIG. 3 is a signal flow diagram illustrating an example operating procedure between an edge data network and a terminal for providing a MEC-based streaming service according to various embodiments.

Referring to FIG. 3, in operation 301, the edge data network 130 may cache a plurality of content related to a streaming service. That is, the edge data network 130 may cache the plurality of content related to the streaming service received from the streamer terminal 210 in operation 207 of FIG. 2. For example, before the edge data network 130 receives a request for the content related to the streaming service from the terminal 110, the edge data network 130 may previously store the plurality of content related to the streaming service. In various embodiments, the edge data network 130 may cache the plurality of content related to the streaming service received from the streamer terminal 210 at specific time intervals (e.g., every 10 minutes), or may cache the plurality of content received within a recent specific time from a current time.

Operation 301 may be performed after operation 207, before operation 209, simultaneously with operation 209, or after operation 209 of FIG. 2. As described in operation 301, because the edge data network 130 previously caches the plurality of content provided from the streamer terminal 210 and provides the content to the terminal 110, a service latency of the terminal 110 using the streaming service may be reduced.

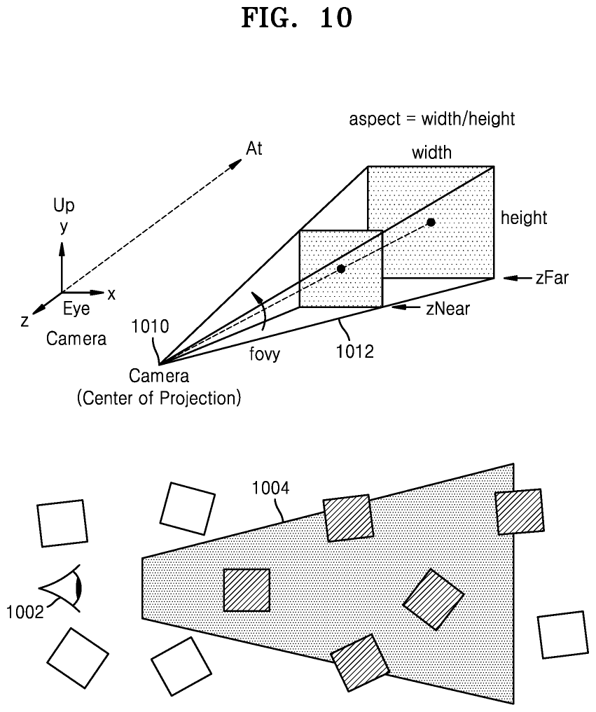

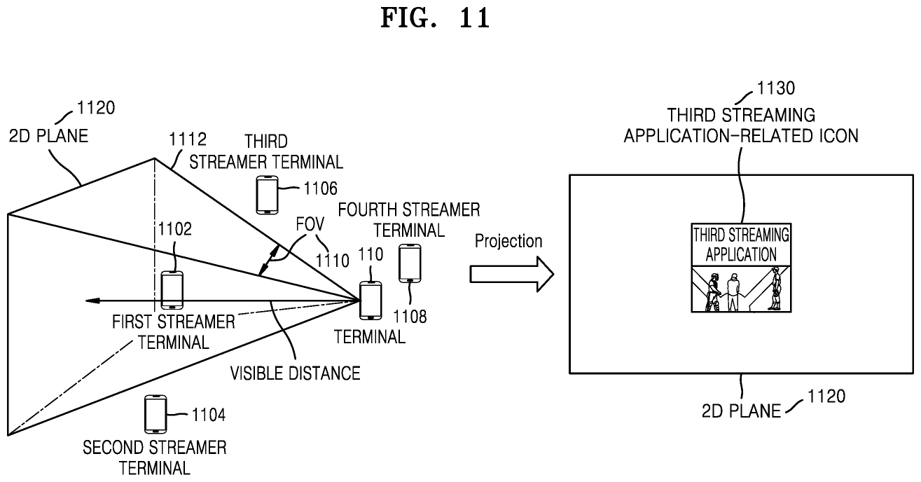

In operation 303, the terminal 110 may transmit a message for requesting content list information corresponding to the terminal 110. In various embodiments, the content list information corresponding to the terminal 110 may refer to content provided by the streamer terminal 210 included in a visual field that may be photographed by a camera of the terminal 110. In various embodiments, the message for requesting the content list information may include information about a location of the terminal 110, a direction of the camera of the terminal 110, or a field of view (FOV) of the camera of the terminal 110. In various embodiments, when the message for requesting the content list information does not include the information about the location of the terminal 110, the edge data network 130 may obtain location information of the terminal 110 from a 3GPP network. The information included in the message for requesting the content list information will be described below in detail with reference to FIGS. 10 and 11. Although operation 303 is performed after operation 301 in FIG. 3, the disclosure is not limited thereto. That is, operation 303 may be performed before or simultaneously with operation 301.

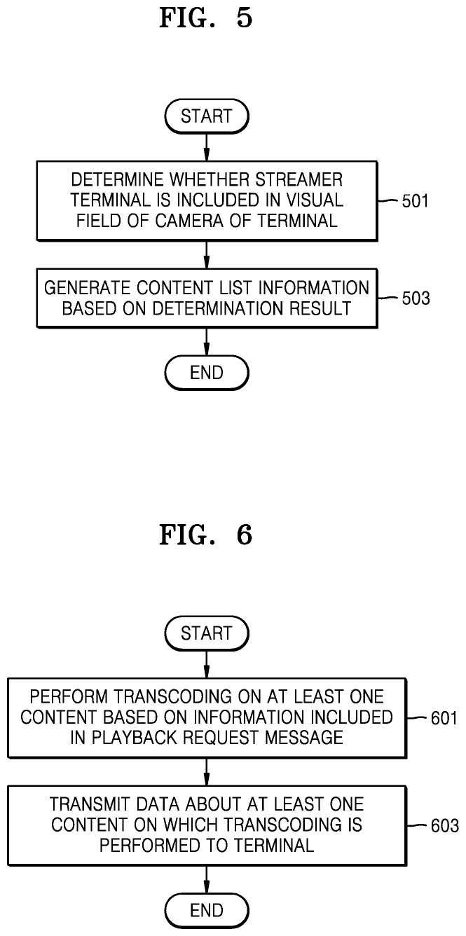

In operation 305, the edge data network 130 may determine the content list information corresponding to the terminal 110 from the cached plurality of content. In various embodiments, the edge data network 130 may determine the content list information corresponding to the terminal 110 based on the information included in the message for requesting the content list information received from the terminal 110 and location information of the streamer terminal 210. In this case, the location information of the streamer terminal 210 may be location information stored in the edge data network 130 in operation 203 of FIG. 2. A method of determining the content list information will be described in detail with reference to FIG. 5.

In various embodiments, the content list information may include content ID information indicating content corresponding to the terminal 110 from among the plurality of content, attribute information (a resolution, a voice, a bit rate, codec information, a content size, a content format, etc.) of the content corresponding to the terminal 110, streamer terminal ID information related to the content corresponding to the terminal, user ID information of the streamer terminal related to the content corresponding to the terminal 110, ID information of a server storing the content corresponding to the terminal 110 (e.g., a MEC server A, a service server B, or an edge data network C), IP information of the server storing the content corresponding to the terminal 110, and information used by the terminal 110 to determine a location for displaying an icon (or information) related to the content on a two-dimensional (2D) plane. Also, the content list information may include information related to a location of the streamer terminal corresponding to the terminal 110, information related to the location of the streamer terminal within a 2D image captured by the terminal 110, and information related to an icon or thumbnail of content provided by the streamer terminal corresponding to the terminal 110.

However, the information that may be included in the content list information is not limited to the above examples, and various information may be included in the content list information.

In various embodiments, the following methods may be considered, as to where the terminal 110 displays the icon (or the information) related to the content on the two-dimensional plane. For example, in a first method, when the edge data network 130 transmits the location information of the streamer terminal 210 to the terminal 110, the terminal 110 may display a content-related icon at a specific location of a map or the 2D image captured by the terminal 110, based on the location information of the streamer terminal 210. In the first method, the information used by the terminal 110 to determine the location for displaying the icon (or information related to the content on the 2D plane) may include the location information of the streamer terminal 210.

In a second method, the edge data network 130 may determine that the content-related icon needs to be displayed at the specific location of the map or the 2D image captured by the terminal 110, based on the location information of the terminal 110. For example, the edge data network 130 may determine to display the content-related icon on a 256th pixel in an X-axis and a 234th pixel in a Y-axis of the 2D image captured by the terminal 110. The edge data network 130 may transmit information about the specific location of the content-related icon to be displayed on the map or the 2D image captured by the terminal 110 to the terminal 110. The terminal 110 may display the content-related icon at the specific location, based on the information about the specific location of the content-related icon received from the edge data network 130. In the second method, the information used by the terminal 110 to determine the location for displaying the icon (or information) related to the content on the 2D plane may include the information about the specific location (e.g., the 256th pixel in the X-axis and the 234th pixel in the Y-axis of the 2D image) of the content-related icon to be displayed on the map or the 2D image captured by the terminal 110.

In a third method, the edge data network 130 may determine to display the content-related icon at a feature point of the map or the 2D image captured by the terminal 110, based on the location information of the terminal 110. For example, the edge data network 130 may determine a chair located second in a right direction from a front door as the feature point, in the 2D image captured by the terminal 110. The edge data network 130 may transmit information about the feature point of the content-related icon to be displayed on the map or the 2D image captured by the terminal 110 to the terminal 110. The terminal 110 may display the content-related icon by tracking the feature point, based on the information about the feature point of the content-related icon received from the edge data network 130. In the third method, the information used by the terminal 110 to determine the location for displaying the icon (or information) related to the content on the 2D plane may include the information about the feature point (e.g., the chair located second in the right direction from the front door in the 2D image) of the content-related icon to be displayed on the map or the 2D image captured by the terminal 110.

However, the information used by the terminal 110 to determine the location for displaying the icon (or information) related to the content on the 2D plane is not limited to the three examples, and various information may be included in the information used by the terminal 110 to determine the location for displaying the icon (or information) related to the content on the 2D plane.

In operation 307, the edge data network 130 may transmit the determined content list information. For example, the edge data network 130 may transmit the content list information corresponding to the terminal 110 determined in operation 305 to the terminal 110. In various embodiments, the content list information corresponding to the terminal 110 may be generated to include an icon related to the content provided by the streamer terminal included in the visual field that may be photographed by the camera of the terminal 110. The edge data network 130 may transmit the content list information including the icon to the terminal 110.

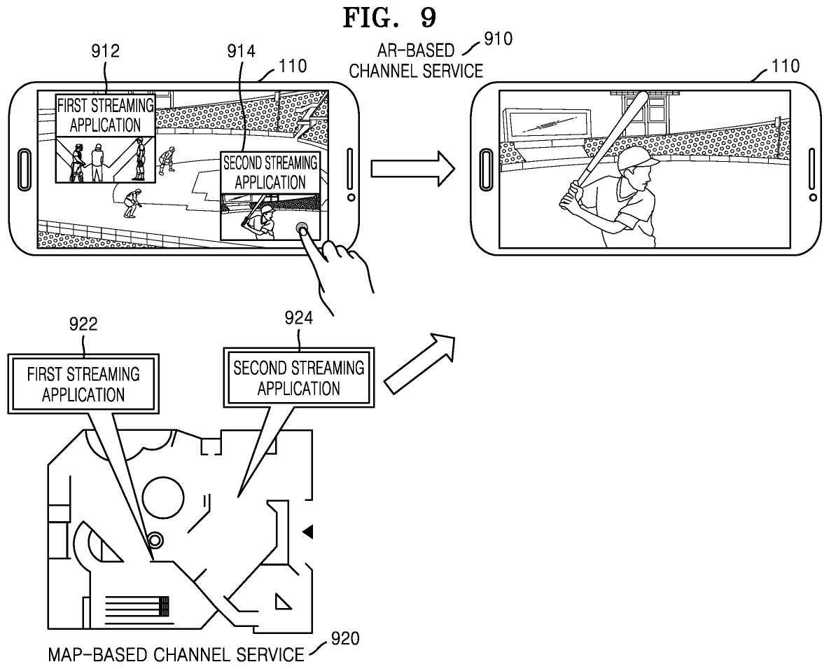

In operation 308, the terminal 110 may display a user interface (UI) based on the received content list information. For example, the terminal 110 may display the UI indicating the received content list information on a display of the terminal 110. For example, the terminal 110 may display the icon (or information) related to the content on the 2D plane captured by the terminal 110, based on the information used by the terminal 110 to determine the location for displaying the icon (or information) related to the content on the 2D plane, included in the content list information. In various embodiments, the terminal may display the icon (or information) related to the content on the 2D plane captured by the terminal 110 based on augmented reality (AR), which will be described in more detail with reference to FIG. 9.

In operation 309, the terminal 110 may transmit a playback request message for content selected based on the content list information. In various embodiments, the terminal 110 may receive the determined content list information from the edge data network 130. The terminal 110 may select specific content based on the received content list information, according to a user input or a rule that is pre-determined in the terminal 110. In order to play the selected content, the terminal 110 may transmit a message for requesting data for playing the selected content to the edge data network 130.

In various embodiments of the disclosure, the pre-determined rule may include a rule for preferentially selecting content of a streamer terminal preferred by a user or a preferred channel pre-input by the user of the terminal 110. Also, the pre-determined rule may include a rule for preferentially selecting content with a low latency during streaming in the terminal 110. Also, the pre-determined rule may include a rule for preferentially selecting content having excellent image quality. Also, the pre-determined rule may include a rule for selecting specific content, in consideration of a previous viewing history of the user. Also, the pre-determined rule may include a rule for preferentially selecting content meeting a requirement of the terminal 110. For example, the requirement of the terminal 110 may include a format, a codec, a resolution, or a bit rate of content that may be played by the terminal 110.

In various embodiments, the playback request message may include information about a network state of the terminal or the requirement of the terminal 110. In various embodiments, the information about the network state of the terminal 110 or the requirement of the terminal 110 may be transmitted by the message for requesting the content list information corresponding to the terminal 110 in operation 303.

In operation 311, the edge data network 130 may perform transcoding on the selected content. That is, the edge data network 130 may perform encoding on data about the selected content, based on the network state of the terminal 110 or the requirement of the terminal 110. An example transcoding method according to the disclosure will be described below in detail with reference to FIG. 6.

In operation 313, the edge data network 130 may transmit the data about the selected content. That is, the edge data network 130 may transmit data for playing the selected content on which transcoding is performed to the terminal 110. Although not shown in FIG. 3, the terminal 110 may receive the data about the selected content and may play the content based on the received data.

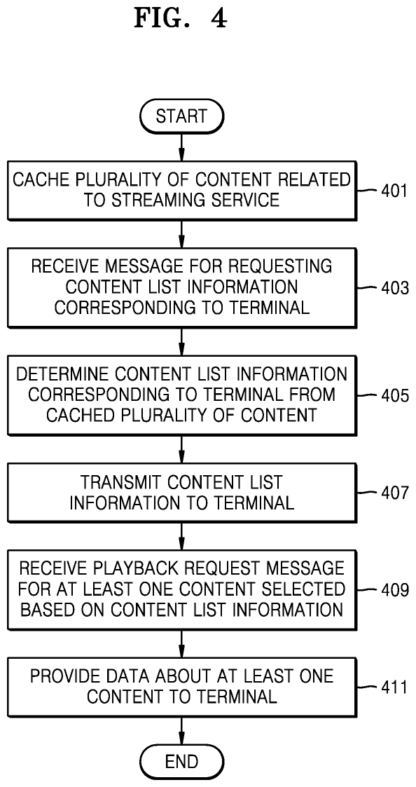

As described with reference to FIG. 3, because the terminal 110 and the edge data network 130 exchange a message with each other, the edge data network 130 may provide the streaming service to the terminal 110. FIG. 4 illustrates an overall example operating procedure performed by the edge data network 130. For convenience of description, the same description as that made with reference to FIG. 3 will not be repeated.

Referring to FIG. 4, in operation 401, the edge data network 130 may cache a plurality of content related to a streaming service. For example, the edge data network 130 may receive a plurality of content related to streaming from at least one streamer terminal that performs the streaming, and may previously store the plurality of content.

In operation 403, the edge data network 130 may receive a message for requesting content list information corresponding to the terminal 110. That is, in order to play content streamed by the at least one streamer terminal in the terminal 110, the terminal 110 may transmit a request message for requesting the content list information to the edge data network 130.

In operation 405, the edge data network 130 may determine the content list information corresponding to the terminal 110 from the cached plurality of content. For example, the edge data network 130 may determine the content list information corresponding to the terminal 110, based on information included in the request message received from the terminal 110. In other embodiments, the edge data network 130 may determine the content list information corresponding to the terminal 110, based on information related to a plurality of content that is not cached in the edge data network 130, but is received from the service server 140.

In operation 407, the edge data network 130 may transmit the content list information to the terminal 110. In various embodiments, the edge data network 130 may generate the content list information by displaying an icon related to content provided by the at least one streamer terminal at a location of the at least one streamer terminal, and may transmit the generated content list information to the terminal 110.

In operation 409, the edge data network 130 may receive a playback request message for at least one content selected based on the content list information. In various embodiments, the terminal 110 may select the at least one content based on the content list information received from the edge data network 130, and may transmit the playback request message to the edge data network 130 to play the selected at least one content.

In operation 411, the edge data network 130 may provide data about the at least one content to the terminal 110. Although not shown in FIG. 4, the edge data network 130 may perform transcoding on the selected at least one content, and may provide transcoded data to the terminal 110.

As described by way of example with reference to FIG. 4, the edge data network 130 may perform an operation for providing the streaming service to the terminal 110. An example method of determining content list information provided to the terminal 110 will be described in detail with reference to FIG. 5.

FIG. 5 is a flowchart illustrating an example operating method of an edge data network for determining content list information according to various embodiments.

Referring to FIG. 5, in operation 501, the edge data network 130 may determine whether the streamer terminal 210 is included in a visual field of a camera of the terminal 110. For example, the edge data network 130 may determine whether the streamer terminal 210 is included in the visual field that may be photographed by the camera of the terminal 110, based on a location of the terminal 110, a direction of the camera of the terminal 110, an FOV of the camera of the terminal 110, and location information of the streamer terminal 210. In various embodiments, the edge data network 130 may obtain the location information of the streamer terminal 210 from the streamer terminal 210 or a 3GPP network.

In operation 503, the edge data network 130 may generate content list information based on a determination result. In various embodiments, when the streamer terminal 210 is included in the visual field that may be photographed by the camera of the terminal 110, the edge data network 130 may add content provided by the streamer terminal 210 to the content list information corresponding to the terminal 110. The edge data network 130 may determine a location of the streamer terminal 210 on a 2D plane onto which the visual field that may be photographed by the camera of the terminal 110 is projected. The edge data network 130 may generate the content list information, by displaying an icon related to the content provided by the streamer terminal 210 at the location of the streamer terminal 210 on the determined 2D plane. That is, the content list information of the disclosure may refer, for example, to information indicating that the icon related to the content provided by the streamer terminal 210 is displayed on the 2D plane. In various embodiments, the icon related to the content provided by the streamer terminal 210 may include a clip image of the content provided by the streamer terminal 210 or a thumbnail related to the content.

In various embodiments, when the streamer terminal 210 is not included in the visual field that may be photographed by the camera of the terminal 110, there may be no content list information corresponding to the terminal 110. Hence, the edge data network 130 may not provide the content list information corresponding to the terminal 110 to the terminal 110. In various embodiments, when the streamer terminal 210 is not included in the visual field that may be photographed by the camera of the terminal 110, the edge data network 130 may transmit a message for changing a location or an angle of the camera to the terminal 110, so that another streamer terminal is included in the visual field of the camera of the terminal 110.

In another embodiments, when the streamer terminal 210 is not included in the visual field that may be photographed by the camera of the terminal 110, the edge data network 130 may request the service server 140 for content-related information including an icon related to a plurality of content and the location information of the streamer terminal 210 related to the plurality of content. The service server 140 may transmit the content or the content-related information received from the streamer terminal 210 to the edge data network 130. Accordingly, the edge data network 130 may generate the content list information, in consideration of the content cached in the service server 140 as well as the content cached in the edge data network 130 itself. As described with reference to FIG. 5, the edge data network 130 may determine the content list information corresponding to the terminal 110, based on information included in a message for requesting the content list information corresponding to the terminal 110 and the location information of the streamer terminal 210. An example method, performed by the edge data network 130, of performing transcoding based on a playback request message received from the terminal 110 will be described in detail with reference to FIG. 6.

FIG. 6 is a flowchart illustrating an example operating method of an edge data network for performing transcoding on content according to various embodiments.

Although not shown in FIG. 6, in various embodiments, the terminal 110 may select at least one content based on content list information received from the edge data network 130, according to a user input or a rule that is pre-determined in the terminal 110. In various embodiments, the pre-determined rule may refer to a rule that is pre-stored in the terminal 110 in order for a user to select content by a user, or a rule that is set by the terminal 110 itself.

Referring to FIG. 6, in operation 601, the edge data network 130 may perform transcoding on at least one content based on information included in a playback request message. According various embodiments, the playback request message may include information about a network state of the terminal 110 or a requirement of the terminal 110. In various embodiments, the requirement of the terminal 110 may include information such as a format, a codec, a resolution, or a bit rate of content that may be played by the terminal 110. Also, the network state of the terminal 110 may include a speed of a network used by the terminal 110.

In various embodiments, transcoding may refer, for example, to a process in which a content providing apparatus for providing content optimizes the content, based on conditions for a playback apparatus for playing the content or various other conditions. For example, the conditions for the playback apparatus may refer to a resolution, a bit rate, or a codec of content that may be played by the playback apparatus.

In various embodiments, the process of optimizing the content may refer to a process of encoding data about the content based on a specific condition. For example, the edge data network 130 of the disclosure may encode data about the selected at least one content, based on the requirement of the terminal 110 or the network state of the terminal 110 that is to play the selected at least one content. Through the encoding, the edge data network 130 may generate the data about the at least one content meeting the requirement of the terminal 110. In various embodiments, the data about the content may refer to a data packet or a data stream required to play the content.

In operation 603, the edge data network 130 may transmit the data about the at least one content on which the transcoding is performed to the terminal 110. For example, the edge data network 130 may transmit the data about the at least one content on which transcoding is performed in operation 601 to the terminal 110 that is to play the content. The terminal 110 may play the content, based on the data about the at least one content on which transcoding is performed.

In various embodiments of the disclosure, the edge data network 130 may transcode the content using an artificial intelligence (AI) codec. According to various embodiments, a method of transcoding content using an AI codec may include AI encoding. For example, the AI encoding may include AI downscaling and first encoding. For example, the edge data network 130 may generate a first image, by performing AI downscaling on an original image having a high resolution. The edge data network 130 may perform first encoding on the first image having a relatively low resolution compared with that of the original image. In this case, a bit rate may be reduced, when compared to a case where the first encoding is performed on the original image having a high resolution. In various embodiments, AI-encoded data may be generated through the AI encoding, that is, the AI downscaling and the first encoding. In various embodiments, the AI-encoded data may include image data and AI data. In various embodiments, the AI-encoded data may refer, for example, to content transcoded by the edge data network 130.

In various embodiments, the edge data network 130 may transmit the AI-encoded data to the terminal 110. The terminal 110 may perform AI decoding based on the AI-encoded data. For example, the terminal 110 may generate a second image by performing first decoding, based on the received AI-encoded data. The terminal 110 may generate a third image by performing AI upscaling on the second image. The terminal 110 may display the generated third image on a display.

As described with reference to FIG. 6, the edge data network 130 may perform a transcoding operation to provide content related to streaming to the terminal 110. In the method of FIG. 6, because the edge data network 130 performs transcoding only when requested by the terminal 110 connected to the edge data network 130, efficient transcoding may be performed. Accordingly, resources used for transcoding of the edge data network 130 may be saved. In various embodiments, the edge data network 130 may identify the terminal 110 connected to the edge data network 130 based on an IP band or the like.

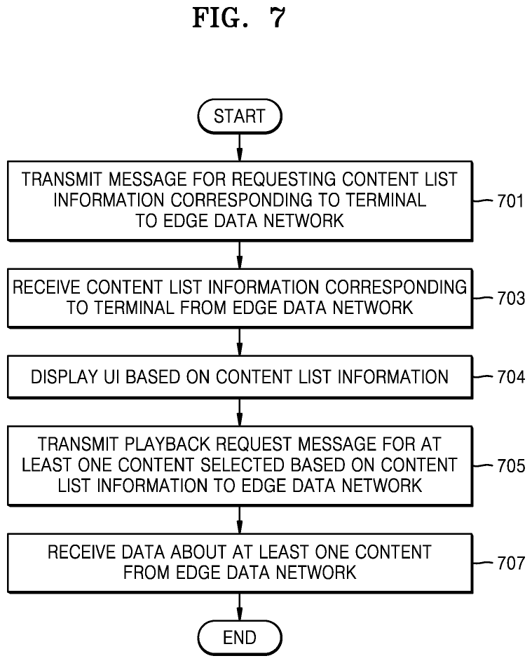

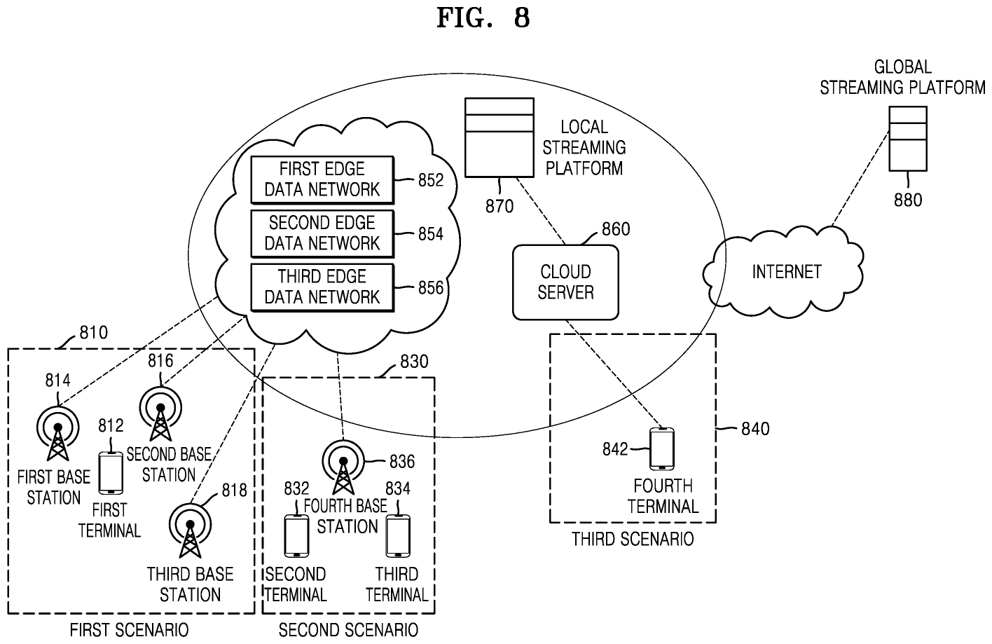

According to various embodiments, the edge data network 130 may select a bit rate and a resolution range of content in consideration of a network speed or the like of the terminal 110. Also, the edge data network 130 other than the service server 140 may perform transcoding on content (e.g., an image). Accordingly, because the edge data network 130 does not need to separately receive data about the content from the service server 140, a latency required to provide the data about the content to the terminal 110 may be reduced. FIG. 7 illustrates an overall example operating procedure performed by the terminal 110. For convenience of description, the same description as that made with reference to FIG. 3 will not be repeated.

FIG. 7 is a flowchart illustrating an example operating method of a terminal according to various embodiments.

Referring to FIG. 7, in operation 701, the terminal 110 may transmit a message for requesting content list information corresponding to the terminal 110 to an edge data network. In various embodiments, the terminal 110 may transmit the message for requesting the content list information corresponding to the terminal 110 to the edge data network 130, in order to see content related to a streaming service.

In operation 703, the terminal 110 may receive the content list information corresponding to the terminal 110 from the edge data network. According to various embodiments, the terminal 110 may receive the content list information corresponding to the terminal 110 determined by the edge data network 130, from the edge data network 130.

In operation 704, the terminal 110 may display a UI based on the content list information. For example, the terminal 110 may display an icon (or information) related to the content on a 2D plane captured by the terminal 110. For example, the terminal 110 may display the icon (or information) related to the content on the 2D plane, based on information used by the terminal 110 to determine a location for displaying the icon (or information) related to the content on the 2D plane, included in the content list information, which will be described in more detail with reference to FIG. 9.

In operation 705, the terminal 110 may transmit a playback request message for at least one content selected based on the content list information to the edge data network 130. In various embodiments, the terminal 110 may select specific content based on the received content list information according to a user input or a rule that is pre-determined in the terminal 110, and may transmit the playback request message for the selected at least one content to the edge data network 130.

In operation 707, the terminal 110 may receive data about the at least one content from the edge data network 130. In various embodiments, the data about the at least one content received from the edge data network 130 may refer to data about at least one content on which transcoding is performed by the edge data network 130. Although not shown in FIG. 7, the terminal 110 may play the content based on the received data about the at least one content.

As described with reference to FIG. 7, the terminal 110 may transmit a message for requesting content to the edge data network 130, and may play the content based on data received from the edge data network 130. FIG. 8 illustrates various example scenarios of providing a streaming service.

FIG. 8 is a diagram illustrating example scenarios of providing a streaming service according to various embodiments.

Referring to FIG. 8, a first terminal 812 may correspond to the streamer terminal 210 of FIG. 2. Also, a second terminal 832, a third terminal 834, and a fourth terminal 842 may correspond to the terminal 110 of FIG. 1. Also, a first base station 814, a second base station 816, a third base station 818, and a fourth base station 836 may be included in the AN 120 of FIG. 1. Also, a first edge data network 852, a second edge data network 854, and a third edge data network 856 may correspond to the edge data network 130 of FIG. 1. Also, a cloud server 860, a local streaming platform 870, and a global streaming platform 880 may correspond to the service server 140 of FIG. 1.

According to an embodiment of the disclosure, the local streaming platform 870 may refer, for example, to a server that may provide content related to a streaming service in a local area (e.g., South Korea). For example, the local streaming platform 870 may refer to a CDN that may provide content related to a streaming service located in a local area (e.g., South Korea).

According to various embodiments, the global streaming platform 880 may refer, for example, to a server (e.g., Google data center in the United States) that may provide content related to a streaming service in a global area (e.g., the world). For example, the global streaming platform 880 may receive a content provision request from the local streaming platform 870, and may transmit requested content through the Internet or an edge data network to the local streaming platform 870.

According to various embodiments, the cloud server 860 may refer, for example, to a server that stores the content provided by the local streaming platform 870 or transmits the content provided by the local streaming platform 870 to the terminal.

According to various embodiments, in a first scenario 810, the first terminal 812 may be connected to at least one edge data network (e.g., the first edge data network 852, the second edge data network 854, or the third edge data network 856) through the first base station 814, the second base station 816, and the third base station 818. The first terminal 812 may perform streaming. For example, the first terminal 812 may perform streaming, by executing an application related to a live broadcast. The first terminal 812 may transmit the content related to the streaming service to at least one edge data network.

According to various embodiments, in a second scenario 830, the at least one edge data network may provide the content related to the streaming service to the second terminal 832 and the third terminal 834 through the fourth base station 836. That is, the second terminal 832 and the third terminal 834 may download the content related to the streaming service provided by the first terminal 812 connected to the same edge data network, from the edge data network.

According to various embodiments, in a third scenario 840, the fourth terminal 842 may download the content related to the streaming service from the local streaming platform 870, through the cloud server 860. Unlike in the third scenario 840, in the first scenario 810 and the second scenario 830, a terminal (e.g., the first terminal 812) that performs streaming and a terminal (e.g., the second terminal 832 and the third terminal 834) that plays streaming content are connected through an edge data network. Accordingly, a latency required to provide the streaming content to the terminal (e.g., the second terminal 832 and the third terminal 834) that plays the streaming content may be reduced.

FIG. 9 is a diagram illustrating an example of providing a streaming service according to various embodiments. For example, in FIG. 9, the terminal 110 displays a UI, based on content list information received from the edge data network 130.

Referring to FIG. 9, an AR-based channel service 910 or a map-based channel service 920 is described. In various embodiments, the AR-based channel service 910 may refer, for example, to a service of providing information about a channel related to a streaming service to the terminal 110, by displaying the channel related to the streaming service using AR on a display of the terminal 110. In various embodiments, the channel related to the streaming service may be included in content related to the streaming service.

For example, a user of the terminal 110 may go to a stadium where a sports event (e.g., a baseball game) is held. The user may photograph a part of the stadium using a camera of the terminal 110. In this case, an icon related to a streamer terminal included in a visual field of the camera of the terminal 110 may be displayed on the display of the terminal 110. For example, a first icon 912 related to a channel provided through a first streaming application by a first streamer terminal and a second icon 914 related to a channel provided through a second streaming application by a second streamer terminal may be displayed on the display of the terminal 110. When the user of the terminal 110 selects the second icon 914, the channel provided through the second streaming application by the second streamer terminal may be provided to the terminal 110. For example, a video streamed by the second streaming application may be played by the terminal 110.

According to various embodiments, the map based channel service 920 may refer to a service of providing information about a channel related to a streaming service to the terminal 110, by displaying the channel related to the streaming service on a map displayed by an application related to the map. For example, when the application related to the map is executed in the terminal 110, the terminal 110 may display the map on the display. An icon related to a streamer terminal may be displayed on the map, based on a location of the streamer terminal. For example, a third icon 922 related to a channel provided through a first streaming application by a third streamer terminal and a fourth icon 924 related to a channel provided through a second streaming application by a fourth streamer terminal may be displayed on the map. In various embodiments, when the user of the terminal 110 selects the third icon 922 or the fourth icon 924, the channel related to the selected icon may be provided to the terminal 110.

As described with reference to FIG. 9, because even when the user of the terminal 110 does not search for a streaming service, a channel related to streaming may be provided to the terminal 110 based on AR or may be provided on a map, the user of the terminal 110 may conveniently search for the channel related to streaming.

FIG. 10 is a diagram illustrating an example method used to generate content list information according to various embodiments.

Referring to FIG. 10, in an embodiment of the disclosure, a visual field may refer to a range (e.g., an angular range, a linear range, or an areal range) that may be observed by a certain object or creature. For example, an eye 1002 may not see all objects around the eye 1002, but may see only objects included in a visual field 1004 of the eye 1002.

In an embodiment of the disclosure, like the eye 1002, a camera may have a visual field. For example, when the camera photographs an object, a view frustum 1012 having a pyramid shape may be formed around a center of projection 1010. The view frustum 1012 may be formed based on an FOV of the camera, and may refer to an angle where the camera may capture an image through a lens. Planes that cut the view frustum 1012 in a direction perpendicular to a viewing direction of the lens may be defined as a near plane and a far plane, and referring to FIG. 10, a near plane may be generated when the view frustum 1012 is cut in the direction perpendicular to the viewing direction at a zNear location, and a far plane may be generated when the view frustum 1012 is cut in the direction perpendicular to the viewing direction at a zFar location. When the camera photographs an object through the lens, the object may be two-dimensionally projected onto the near plane or the far plane.

Content list information using AR may be provided to the terminal 110, based on the principle described with reference to FIG. 10. For example, as described with reference to FIG. 3, the edge data network 130 may receive a message for requesting the content list information corresponding to the terminal 110 from the terminal 110, and may determine the content list information corresponding to the terminal 110 from a plurality of content. In order to determine the content list information corresponding to the terminal 110, the edge data network 130 may determine whether a streamer terminal is included in a visual field of the camera of the terminal 110 and may generate the content list information according to a determination result as described with reference to FIG. 5. An example method of generating content list information corresponding to the terminal 110 will be described in detail with reference to FIG. 11.

FIG. 11 is a diagram illustrating an example method of generating content list information using AR according to various embodiments.

Referring to FIG. 11, a view frustum 1112 of the terminal 110 may be formed based on an FOV 1110 of a camera, in a viewing direction of a camera lens of the terminal 110. In this case, a 2D plane 1120 may be formed within a visible distance where the camera of the terminal 110 may capture an image, in the view frustum 1112 of the terminal 110. In various embodiments, an object photographed by the camera of the terminal 110 may be projected onto the 2D plane 1120.

According to various embodiments, the edge data network 130 may receive a DNS request related to a streaming service from streamer terminals, and may store location information of the streamer terminals. The edge data network 130 may identify a streamer terminal included in the view frustum 1112 of the terminal 110, based on the stored location information of the streamer terminals. For example, the edge data network 130 may determine that a first streamer terminal 1102 is included in the view frustum 1112 of the terminal 110, based on the stored location information of the streamer terminals. Also, the edge data network 130 may determine that a second streamer terminal 1104, a third streamer terminal 1106, and a fourth streamer terminal 1108 are not included in the view frustum 1112 of the terminal 110, based on the stored location information of the streamer terminals.

According to various embodiments, the edge data network 130 may determine that the first streamer terminal 1102 is included in the view frustum 1112 of the terminal 110, and then may project the first streamer terminal 1102 onto the 2D plane 1120 of the view frustum 1112. The edge data network 130 may calculate 2D coordinates of a location at which the first streamer terminal 1102 is projected. The edge data network 130 may display a third streaming application-related icon 1130 streamed by the first streamer terminal 1102, on the calculated 2D coordinates. In various embodiments, the third streaming application-related icon 1130 may include a clip image or a thumbnail of an image streamed through the third streaming application.

In various embodiments, the edge data network 130 may provide content list information corresponding to the terminal 110, to an image captured by the camera of the terminal 110. The terminal 110 may output an AR image by displaying an icon indicating the content list information corresponding to the terminal 110 to overlap the image captured by the camera of the terminal 110.

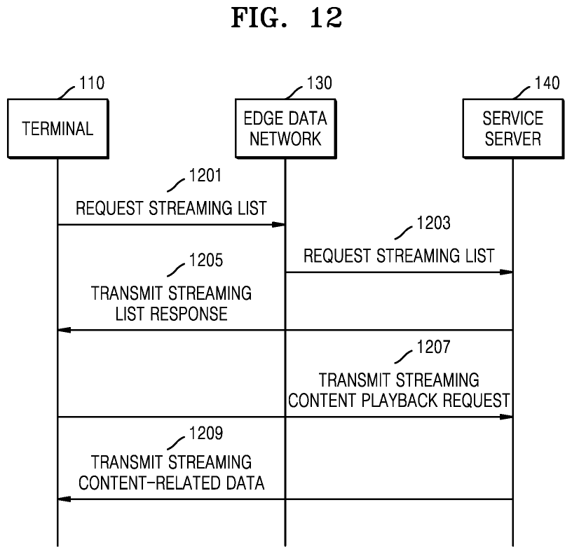

As described with reference to FIG. 11, the edge data network 130 may generate content list information corresponding to the terminal 110, by displaying an icon related to content provided by a streamer terminal on the 2D plane 1120 of the view frustum 1112 of the terminal 110. The edge data network 130 may provide the generated content list information to the terminal 110. FIG. 12 illustrates an example method of providing content related to a streaming service, in a scenario in which the edge data network 130 generally exists.

FIG. 12 is a signal flow diagram illustrating an example procedure of providing content related to a streaming service according to various embodiments.

In FIG. 12, a network environment may include the terminal 110, the edge data network 130, and the service server 140. However, the disclosure is not limited thereto, and the network environment of FIG. 12 may further include additional elements.

Referring to FIG. 12, in operation 1201, the terminal 110 may request a streaming list. For example, the terminal 110 may request the edge data network 130 for a list of streaming content, in order to play the streaming content that is broadcast in real time.

In operation 1203, the edge data network 130 may request the streaming list. That is, the terminal 110 may request the edge data network 130 for the streaming list, and then the edge data network 130 may request the service server 140 for the streaming list.

In operation 1205, the service server 140 may transmit a streaming list response. For example, the service server 140 may provide the list of the streaming content to the terminal 110, in response to a streaming list request from the edge data network 130. In various embodiments, the streaming list may include an identifier for identifying the streaming content, and a uniform resource locator (URL) corresponding to the streaming content. Although the streaming list response is directly transmitted to the terminal 110 from the service server 140 in operation 1205 of FIG. 12, the disclosure is not limited thereto. For example, the edge data network 130 may receive the streaming list response from the service server 140, and may transmit the streaming list response to the terminal 110.

In operation 1207, the terminal 110 may transmit a streaming content playback request. In various embodiments, the terminal 110 may request the service server 140 to play the streaming content selected in the streaming list, based on the streaming list provided by the service server 140. Although the streaming content playback request is directly transmitted from the terminal 110 to the service server 140 in FIG. 12, the disclosure is not limited thereto. For example, the edge data network 130 may receive the streaming content playback request from the terminal 110 and may transmit the streaming content playback request to the service server 140.

In operation 1209, the service server 140 may transmit streaming content-related data. In various embodiments, the service server 140 may transmit data related to the streaming content requested by the terminal 110 to the terminal 110, based on the streaming content playback request from the terminal 110. Although not shown in FIG. 12, the terminal 110 may receive the data related to the streaming content from the service server 140, and may play the streaming content based on the received data.

As described with reference to FIG. 12, in general, the edge data network 130 may request the service server 140 for a streaming list, and the service server 140 may transmit the streaming list and streaming content-related data to the terminal 110. In contrast, in various embodiments of the disclosure, the edge data network 130 may cache a plurality of content related to a streaming service, and may provide the cached plurality of content to the terminal 110. Accordingly, in an embodiment of the disclosure, when compared to a method of FIG. 12, a latency due to a transmission/reception procedure with the service server 140 may be reduced. Also, because a streaming list based on AR may be provided to the terminal 110 according to various embodiments, convenience in live broadcast channel searching and switching of a user of the terminal 110 may be improved.

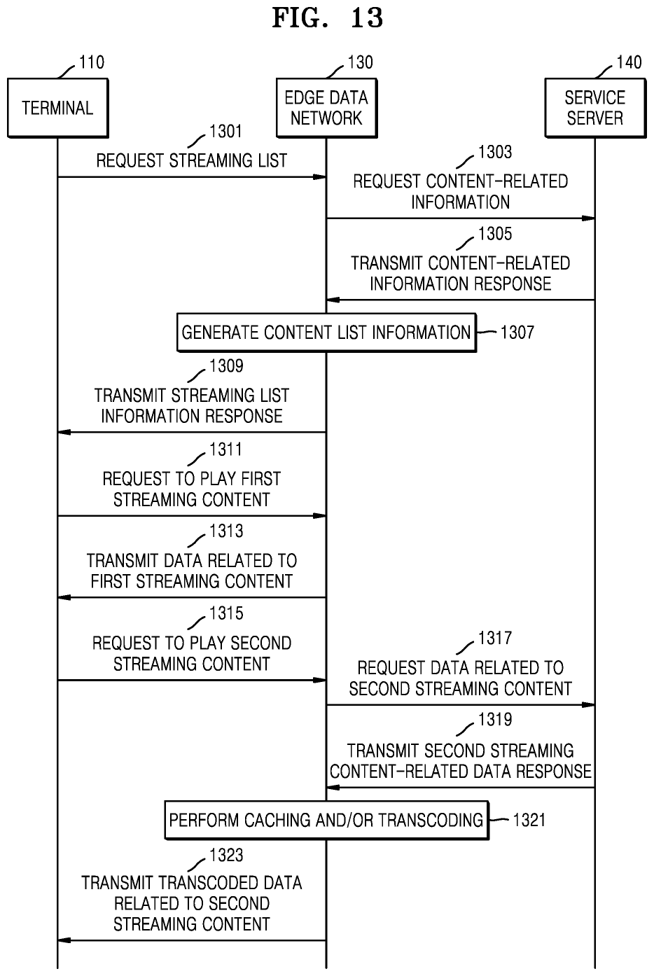

FIG. 13 is a signal flow diagram illustrating an example procedure of providing content related to a streaming service according to various embodiments.

Referring to FIG. 13, in operation 1301, the terminal 110 may request the edge data network 130 for streaming list information. For example, the terminal 110 may request the edge data network 130 for list information about streaming content, in order to play the streaming content that is broadcast in real time.

In operation 1303, the edge data network 130 may request the service server 140 for content-related information. In various embodiments, the content-related information may include an icon related to content and location information of a streamer terminal that transmits the content.

In operation 1305, the service server 140 may transmit a content-related information response to the edge data network 130. In various embodiments, when the streamer terminal is not connected to the edge data network 130, the streamer terminal may transmit the content-related information to the service server 140, and as in operations 1303 and 1305, the edge data network 130 may request the service server 140 for the content-related information and may receive a request response. Alternatively, in various embodiments, when the edge data network 130 previously stores the content-related information, operations 1303 and 1305 may be omitted.

In operation 1307, the edge data network 130 may generate content list information. For example, the edge data network 130 may generate the content list information corresponding to the terminal 110, based on content cached in the edge data network 130 itself and the content-related information received from the service server 140.

In operation 1309, the edge data network 130 may transmit a streaming list information response to the terminal 110. For example, the edge data network 130 may transmit the streaming list information response including the generated content list information to the terminal 110.

In operation 1311, the terminal 110 may request the edge data network 130 to play first streaming content. For example, the terminal 110 may select the first streaming content, based on the streaming list information received from the edge data network 130. The terminal 110 may request the edge data network 130 to play the selected first streaming content.

In operation 1313, the edge data network 130 may transmit data related to the first streaming content to the terminal 110. In various embodiments, the edge data network 130 may previously cache the data related to the first streaming content before a request of the data related to the first streaming content of the terminal 110. The edge data network 130 may transmit the data related to the first streaming content to the terminal 110 in response to the request of the terminal 110. That is, the edge data network 130 may not request the service server 140 for the data related to the first streaming content, and may provide the data related to the first streaming content that is cached in the edge data network 130 itself to the terminal 110.

In operation 1315, the terminal 110 may request the edge data network 130 to play second streaming content. For example, the terminal 110 may select the second streaming content, based on the streaming list information received from the edge data network 130. The terminal 110 may request the edge data network 130 to play the selected second streaming content.

In operation 1317, the edge data network 130 may request the service server 140 for data related to the second streaming content. In various embodiments, when the edge data network 130 does not store the data related to the second streaming content, that is, does not previously cache the data related to the second streaming content, the edge data network 130 may request the service server 140 for the data related to the second streaming content.

In operation 1319, the service server 140 may transmit a second streaming content-related data response to the edge data network 130. That is, the service server 140 may transmit the second streaming content-related data response to the edge data network 130, in response to a request from the edge data network 130.

In operation 1321, the edge data network 130 may perform caching and/or transcoding. In various embodiments, the edge data network 130 may receive the data related to the second streaming content from the service server 140. The edge data network 130 may cache the received data related to the second streaming content. The edge data network 130 may transcode the data related to the second streaming content. In various embodiments, the edge data network 130 may not cache the data related to the second streaming content, but may transcode the data related to the second streaming content and may provide the transcoded data related to the second streaming content to the terminal 110. Alternatively, in various embodiments, the edge data network 130 may cache the data related to the second streaming content, may transcode the cached data related to the second streaming content, and may provide the transcoded data related to the second streaming content to the terminal 110. Alternatively, in various embodiments, the edge data network 130 may transcode the data related to the second streaming content, and then may cache the data related to the second streaming content.

In operation 1323, the edge data network 130 may transmit the transcoded data related to the second streaming content to the terminal 110. For example, the edge data network 130 may perform transcoding on the data related to the second streaming content in operation 1321, and may transmit the transcoded data related to the second streaming content to the terminal 110. Although not shown in FIG. 13, the terminal 110 may play the second streaming content, based on the data related to the second streaming content received from the edge data network 130.

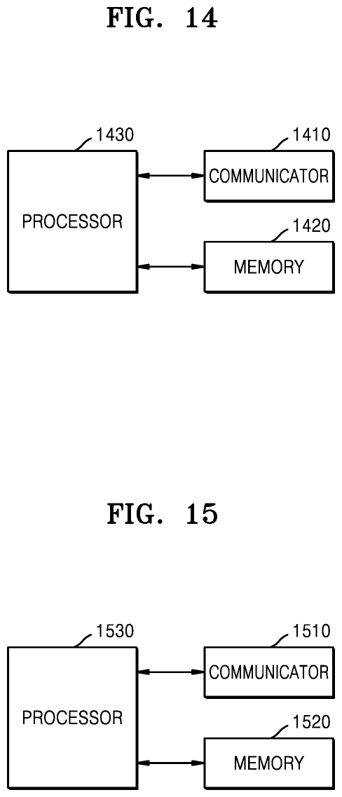

FIGS. 14 and 15 illustrate example configurations of the edge data network 130 and the terminal 110 according to various embodiments.

FIG. 14 is a block diagram illustrating an example configuration of an edge data network according to various embodiments.

As shown in FIG. 14, the edge data network 130 of the disclosure may include a processor (e.g., including processing circuitry) 1430, a communicator (e.g., including communication circuitry) 1410, and a memory 1420. However, elements of the edge data network 130 are not limited to those illustrated in FIG. 14. For example, the edge data network 130 may include more elements or fewer elements than those illustrated in FIG. 14. Also, the processor 1430, the communicator 1410, and the memory 1420 may be implemented as one chip.

According to various embodiments, the processor 1430 may include various processing circuitry and control a series of processes so that the edge data network 130 operates according to embodiments of the disclosure discussed above. For example, the processor 1430 may control elements of the edge data network 130 to perform a method of providing a streaming service according to various embodiments. A plurality of processors 1430 may be provided, and the processor 1430 may perform an operation of providing a streaming service by executing a program (or a plurality of instructions) stored in the memory 1420.

The communicator 1410 may include various communication circuitry and transmit or receive a signal to or from an external device (e.g., the terminal 110, the AN 120, the service server 140, or a 3GPP network). The signal transmitted/received to/from the external device may include control information and data. The communicator 1410 may include a radio frequency (RF) transmitter that up-converts and amplifies a frequency of a transmitted signal, and an RF receiver that performs low-noise amplification on a received signal and down-converts a frequency. However, this is merely an example of the communicator 1410, and elements of the communicator 1410 are not limited to the RF transmitter and the RF receiver. Also, the communicator 1410 may receive a signal through a wireless channel, may output the signal to the processor 1430, and may transmit a signal output from the processor 1430 through the wireless channel.

According to various embodiments, the memory 1420 may store a program and data necessary to operate the edge data network 130. Also, the memory 1420 may store control information or data included in a signal transmitted/received by the edge data network 130. The memory 1420 may include a storage medium such as a read-only memory (ROM), a random-access memory (RAM), a hard disk, a compact disc-ROM (CD-ROM), or a digital versatile disk (DVD), or a combination of storage media. Also, a plurality of memories 1420 may be provided. According to various embodiments, the memory 1420 may store a program (or a plurality of instructions) for performing an operation of providing a streaming service according to various embodiments of the disclosure.

FIG. 15 is a block diagram illustrating an example configuration of a terminal according to various embodiments.

As shown in FIG. 15, the terminal 110 of the disclosure may include a processor (e.g., including processing circuitry) 1530, a communicator (e.g., including communication circuitry) 1510, and a memory 1520. However, elements of the terminal 110 are not limited to those illustrated in FIG. 15. For example, the terminal 110 may include more elements or fewer elements than those illustrated in FIG. 15. Also, the processor 1530, the communicator 1510, and the memory 1520 may be implemented as one chip.

According to various embodiments, the processor 1530 may include various processing circuitry and control a series of processes so that the terminal 110 operates according to embodiments of the disclosure discussed above. For example, the processor 1530 may control elements of the terminal 110 to perform a method of receiving a streaming service according to various embodiments of the disclosure. A plurality of processors 1530 may be provided, and the processor 1530 may perform an operation of receiving a streaming service by executing a program stored in the memory 1520.

The communicator 1510 may include various communication circuitry and transmit or receive a signal to or from an external device (e.g., the AN 120, the edge data network 130, the service server 140, or a 3GPP network). The signal transmitted/received to/from the external device may include control information and data. The communicator 1510 may include an RF transmitter that up-converts and amplifies a frequency of a transmitted signal, and an RF receiver that performs low-noise amplification on a received signal and down-converts a frequency. However, this is merely an example of the communicator 1510, and elements of the communicator 1510 are not limited to the RF transmitter and the RF receiver. Also, the communicator 1510 may receive a signal through a wireless channel, may output the signal to the processor 1530, and may transmit a signal output from the processor 1530 through the wireless channel.

According to various embodiments, the memory 1520 may store a program (or a plurality of instructions) and data necessary to operate the terminal 110. Also, the memory 1520 may store control information or data included in a signal transmitted/received by the terminal 110. The memory 1520 may include a storage medium such as a ROM, a RAM, a hard disk, a CD-ROM, or a DVD, or a combination storage media. Also, a plurality of memories 1520 may be provided. According to various embodiments, the memory 1520 may store a program (or a plurality of instructions) for performing an operation of receiving a streaming service according to embodiments of the disclosure discussed above.

According to various embodiments, a method, performed by an edge data network, of providing a streaming service to a terminal may include caching a plurality of content related to the streaming service; receiving a message for requesting content list information corresponding to the terminal, from the terminal; determining the content list information corresponding to the terminal, from the cached plurality of content, based on the message for requesting the content list information; transmitting the determined content list information to the terminal; receiving a playback request message for at least one content selected based on the content list information from the terminal; and providing data about the at least one content to the terminal, based on the playback request message.

The method according to various embodiments may further include storing location information of a streamer terminal that provides the plurality of content related to the streaming service, in response to a domain name system (DNS) request of the streamer terminal.

According to various embodiments, the message for requesting the content list information may include information about at least one of a location of the terminal, a direction of a camera of the terminal, or a field of view (FOV) of the camera of the terminal.

According to various embodiments, the determining of the content list information corresponding to the terminal from the cached plurality of content may include determining the content list information corresponding to the terminal, based on information included in the message for requesting the content list information and the location information of the streamer terminal.

According to various embodiments, the determining of the content list information corresponding to the terminal may include determining whether the streamer terminal is included in a visual field of the camera of the terminal, based on the location of the terminal, the direction of the camera of the terminal, the FOV of the camera of the terminal, and the location information of the streamer terminal; and generating the content list information by displaying an icon related to the plurality of content provided by the streamer terminal, at a location of the streamer terminal on a 2D plane onto which the visual field of the camera of the terminal is projected, based on a determination result.

According to various embodiments, the playback request message may include information about a network state of the terminal or a requirement of the terminal, and the requirement of the terminal may include information about at least one of a format, a codec, or a resolution of content played (or playable) by the terminal.

According to various embodiments, the providing of the data about the at least one content to the terminal may include performing transcoding on the at least one content, based on information included in the playback request message; and transmitting the data about the at least one content on which the transcoding is performed to the terminal.

According to various embodiments, an operating method of a terminal for receiving a streaming service from an edge data network may include transmitting a message for requesting content list information corresponding to the terminal to the edge data network; receiving the content list information corresponding to the terminal determined from a plurality of cached content related to the streaming service, from the edge data network; transmitting a playback request message for at least one content selected based on the content list information to the edge data network; and receiving data about the at least one content, from the edge data network.

According to various embodiments, the message for requesting the content list information may include information about at least one of a location of the terminal, a direction of a camera of the terminal, or a field of view (FOV) of the camera of the terminal.

According to various embodiments, the playback request message may include information about a network state of the terminal or a requirement of content played (or playable) by the terminal, wherein the requirement includes information about at least one of a format, a codec, or a resolution of the content played (or playable) by the terminal.

According to various embodiments, an edge data network for providing a streaming service to a terminal may include a communicator (e.g., including communication circuitry); a memory configured to store a plurality of instructions; and a processor configured to execute the plurality of instructions to cache a plurality of content related to the streaming service, receive a message for requesting content list information corresponding to the terminal from the terminal, determine the content list information corresponding to the terminal from the cached plurality of content based on the message for requesting the content list information, transmit the determined content list information to the terminal, receive a playback request message for at least one content selected based on the content list information from the terminal, and provide data about the at least one content to the terminal based on the playback request message.

According to various embodiments, the processor may be further configured to execute the plurality of instructions to store location information of a streamer terminal that provides the plurality of content related to the streaming service, in response to a domain name system (DNS) request of the streamer terminal.

According to various embodiments, the message for requesting the content list information may include information about at least one of a location of the terminal, a direction of a camera of the terminal, or a field of view (FOV) of the camera of the terminal.

According to various embodiments, the processor may be further configured to execute the plurality of instructions to determine the content list information corresponding to the terminal, based on information included in the message for requesting the content list information and the location information of the streamer terminal.

According to various embodiments, the processor may be further configured to execute the plurality of instructions to determine whether the streamer terminal is included in a visual field of the camera of the terminal, based on the location of the terminal, the direction of the camera of the terminal, the FOV of the camera of the terminal, and the location information of the streamer terminal, and generate the content list information by displaying an icon related to the plurality of content provided by the streamer terminal, at a location of the streamer terminal on a 2D plane onto which the visual field of the camera of the terminal is projected, based on a determination result.

According to various embodiments, the playback request message may include information about a network state of the terminal or a requirement of the terminal, wherein the requirement of the terminal includes information about at least one of a format, a codec, or a resolution of content played by the terminal.

According to various embodiments, the processor may be further configured to execute the plurality of instructions to perform transcoding on the at least one content, based on information included in the playback request message, and transmit the data about the at least one content on which the transcoding is performed to the terminal.

According to various embodiments, a terminal for receiving a streaming service from an edge data network may include a communicator; a memory configured to store a plurality of instructions; and a processor configured to execute the plurality of instructions to transmit a message for requesting content list information corresponding to the terminal to the edge data network, receive the content list information corresponding to the terminal determined from a plurality of cached content related to the streaming service from the edge data network, transmit a playback request message for at least one content selected based on the content list information to the edge data network, and receive data about the at least one content from the edge data network.

According to various embodiments, the message for requesting the content list information may include information about at least one of a location of the terminal, a direction of a camera of the terminal, or a field of view (FOV) of the camera of the terminal.

According to various embodiments, the playback request message may include information about a network state of the terminal or a requirement of the terminal, wherein the requirement of the terminal includes information about at least one of a format, a codec, or a resolution of content played by the terminal.

Methods according to embodiments of the disclosure described in the claims or specification may be implemented in a form of hardware, software, or a combination of hardware and software.

When the methods are implemented as software, a computer-readable storage medium or a computer program product storing one or more programs (software modules) may be provided. The one or more programs stored in the computer-readable storage medium or the computer program product are configured to be executed by one or more processors in an electronic device. The one or more programs include instructions for allowing the electronic device to perform the methods according to the embodiments of the disclosure described in the claims or specification.

Such programs (software modules or software) may be stored in a random-access memory (RAM), a non-volatile memory including a flash memory, a read-only memory (ROM), an electrically erasable programmable read-only memory (EEPROM), a magnetic disc storage device, a compact disc-ROM (CD-ROM), a digital versatile disc (DVD) or another type of optical storage device, or a magnetic cassette. Alternatively, the programs may be stored in a memory combined by combining some or all of the them. Also, each configured memory may include a plurality of memories.

Also, the programs may be stored in an attachable storage device accessible through a communication network such as the Internet, an intranet, a local area network (LAN), a wide LAN (WLAN), or a storage area network (SAN), or a combination thereof. The storage device may access a device for performing embodiments of the disclosure through an external port. Also, a separate storage device on a communication network may access the device for performing embodiments of the disclosure.

The term “computer program product” or “computer-readable medium” used herein may be used to collectively refer to a medium such as a memory, a hard disk mounted on a hard disk drive, and a signal. The “computer program product” or “computer-readable recording medium” refers to a configuration for providing, to a computer system, software including instructions for caching a plurality of content related to a streaming service, receiving a message for requesting content list information corresponding to a terminal from the terminal, determining the content list information corresponding to the terminal from the cached plurality of content based on the message for requesting the content list information, transmitting the determined content list information to the terminal, receiving a playback request message for at least one content selected based on the content list information from the terminal, and providing data about the at least one content to the terminal based on the playback request message according to the disclosure.

In specific embodiments of the disclosure, components of the disclosure are expressed singular or plural according to the specific embodiments of the disclosure. However, singular or plural representations are selected appropriately for the sake of convenience of explanation, the disclosure is not limited to singular or plural constituent elements, and even expressed as a singular element, it may be composed of plural elements, and vice versa.

Embodiments of the disclosure provide an apparatus and method capable of effectively providing a MEC-based streaming service.

While the disclosure has been illustrated and described with reference to various example embodiments, it will be understood that the various example embodiments are intended to be illustrative, not limiting. It will be further understood by one of ordinary skill in the art that various changes in form and detail may be made without departing from the true spirit and full scope of the disclosure, including the appended claims and equivalents thereof.

What is claimed is:

1. A method, performed by an edge data network, of providing a streaming service to a terminal, the method comprising:
caching a plurality of content related to the streaming service;
receiving, from the terminal, a message for requesting content list information corresponding to the terminal;
determining the content list information corresponding to the terminal from the cached plurality of content, based on the message for requesting the content list information;
transmitting the determined content list information to the terminal;
receiving, from the terminal, a playback request message for at least one content selected based on the content list information; and
providing, to the terminal, data about the at least one content, based on the playback request message.

2. The method of claim 1, further comprising storing location information of a streamer terminal that provides the plurality of content related to the streaming service, in response to a domain name system (DNS) request of the streamer terminal.

3. The method of claim 2, wherein the message for requesting the content list information comprises information about at least one of a location of the terminal, a direction of a camera of the terminal, or a field of view (FOV) of the camera of the terminal.

4. The method of claim 3, wherein the determining of the content list information corresponding to the terminal from the cached plurality of content comprises determining the content list information corresponding to the terminal, based on information included in the message for requesting the content list information and the location information of the streamer terminal.

5. The method of claim 4, wherein the determining of the content list information corresponding to the terminal comprises:
determining whether the streamer terminal is included in a visual field of the camera of the terminal, based on the location of the terminal, the direction of the camera of the terminal, the FOV of the camera of the terminal, and the location information of the streamer terminal;
generating the content list information by displaying an icon related to the plurality of content provided by the streamer terminal, at a location of the streamer terminal on a two-dimensional (2D) plane onto which the visual field of the camera of the terminal is projected, based on a determination result.

6. The method of claim 1, wherein the playback request message comprises information about a network state of the terminal or a requirement of the terminal,
wherein the requirement of the terminal comprises information about at least one of a format, a codec, or a resolution of content playable by the terminal.

7. The method of claim 6, wherein the providing of the data about the at least one content to the terminal comprises:
performing transcoding on the at least one content, based on the information included in the playback request message; and
transmitting the data about the at least one content on which the transcoding is performed to the terminal.

8. An operating method of a terminal for receiving a streaming service from an edge data network, the operating method comprising:
transmitting, to the edge data network, a message for requesting content list information corresponding to the terminal
receiving, from the edge data network, the content list information corresponding to the terminal determined from a plurality of cached content related to the streaming service;
transmitting, to the edge data network, a playback request message for at least one content selected based on the content list information; and
receiving data about the at least one content, from the edge data network.

9. The operating method of claim 8, wherein the message for requesting the content list information comprises information about at least one of a location of the terminal, a direction of a camera of the terminal, or a field of view (FOV) of the camera of the terminal.

10. The operating method of claim 8, wherein the playback request message comprises information about a network state of the terminal or a requirement of content played by the terminal,
wherein the requirement comprises information about at least one of a format, a codec, or a resolution of the content playable by the terminal.

11. An edge data network for providing a streaming service to a terminal, the edge data network comprising:
a communicator;
a memory storing a plurality of instructions; and
a processor configured to execute the plurality of instructions to:
cache a plurality of content related to the streaming service,
receive, from the terminal, a message for requesting content list information corresponding to the terminal,
determine the content list information corresponding to the terminal, from the cached plurality of content, based on the message for requesting the content list information,
transmit the determined content list information to the terminal,
receive, from the terminal, a playback request message for at least one content selected based on the content list information, and
provide, to the terminal, data about the at least one content, based on the playback request message.

12. The edge data network of claim 11, wherein the processor is further configured to execute the plurality of instructions to store location information of a streamer terminal that provides the plurality of content related to the streaming service, in response to a domain name system (DNS) request of the streamer terminal.

13. The edge data network of claim 12, wherein the message for requesting the content list information comprises information about at least one of a location of the terminal, a direction of a camera of the terminal, or a field of view (FOV) of the camera of the terminal.

14. The edge data network of claim 13, wherein the processor is further configured to execute the plurality of instructions to determine the content list information corresponding to the terminal, based on information included in the message for requesting the content list information and the location information of the streamer terminal.

15. The edge data network of claim 14, wherein the processor is further configured to execute the plurality of instructions to:
determine whether the streamer terminal is included in a visual field of the camera of the terminal, based on the location of the terminal, the direction of the camera of the terminal, the FOV of the camera of the terminal, and the location information of the streamer terminal, and
generate the content list information by displaying an icon related to the plurality of content provided by the streamer terminal, at a location of the streamer terminal on a two-dimensional (2D) plane onto which the visual field of the camera of the terminal is projected, based on a determination result.

16. The edge data network of claim 11, wherein the playback request message comprises information about a network state of the terminal or a requirement of the terminal,
wherein the requirement of the terminal comprises information about at least one of a format, a codec, or a resolution of content playable by the terminal.

17. The edge data network of claim 16, wherein the processor is further configured to execute the plurality of instructions to:
perform transcoding on the at least one content, based on the information included in the playback request message, and
transmit the data about the at least one content on which the transcoding is performed to the terminal.

18. A terminal for receiving a streaming service from an edge data network, the terminal comprising:
a communicator;
a memory storing a plurality of instructions; and
a processor configured to execute the plurality of instructions to:
transmit, to the edge data network, a message for requesting content list information corresponding to the terminal,
receive, from the edge data network, the content list information corresponding to the terminal determined from a plurality of cached content related to the streaming service,
transmit, to the edge data network, a playback request message for at least one content selected based on the content list information, and
receive data about the at least one content, from the edge data network.

19. The terminal of claim 18, wherein the message for requesting the content list information comprises information about at least one of a location of the terminal, a direction of a camera of the terminal, or a field of view (FOV) of the camera of the terminal.

20. The method of claim 18, wherein the playback request message comprises information about a network state of the terminal or a requirement of the terminal,
wherein the requirement of the terminal comprises information about at least one of a format, a codec, or a resolution of content playable by the terminal.
